(19) United States
(12) Patent Application Publication
(10) Pub. No.: US 2023/0137980 A1
(43) Pub. Date: May 4, 2023

(54) REMOTE MONITORING AND CONTROL APPARATUS, SYSTEM, METHOD, AND NON-TRANSITORY COMPUTER READABLE MEDIUM STORING PROGRAM

(71) Applicant: NEC Corporation, Minato-ku, Tokyo (JP)

(72) Inventors: Takashi Yamane, Tokyo (JP); Masayuki Sakata, Tokyo (JP); Takanori lwai, Tokyo (JP); Koichi Nihei, Tokyo (JP); Kosei Kobayashi, Tokyo (JP); Yusuke Shinohara, Tokyo (JP)

(73) Assignee: NEC Corporation, Minato-ku, Tokyo (JP)

(21) Appl. No.: 17/912,115

(22) PCT Filed: Mar. 31, 2020
(86) PCT No.: PCT/JP2020/014731

§ 371 Date: Sep. 16, 2022

(51) Int. Cl. G05D 1/00; G06F 3/14; B60W 60/00; B60W 50/14

(52) U.S. Cl. CPC G05D 1/0038; G06F 3/1423; B60W 60/001; B60W 50/14; B60W 60/005; G05D 1/0016; B60W 2050/146; B60W 2756/10; B60W 2556/45; B60W 2420/42

(57) ABSTRACT

A main object of the present disclosure is to provide a remote monitoring and control apparatus, a system, a method, and a non-transitory computer readable medium storing a program capable of improving the monitoring efficiency of a mobile body when the mobile body is remotely monitored and controlled. A remote monitoring and control apparatus according to the present disclosure includes: determination result acquisition means for acquiring a result of determination as to whether or not a mobile body is able to perform autonomous driving; display means for displaying at least one of a monitor screen for displaying video image data captured from the mobile body in a direction external thereto for each of a plurality of the mobile bodies and a remote control screen for displaying the video image data of a remotely controlled mobile body selected from among the plurality of the mobile bodies.

### TECHNICAL FIELD

The present disclosure relates to a remote monitoring and control apparatus, a system, a method, and a non-transitory computer readable medium storing a program, and in particular, to a remote monitoring and control apparatus, a system, a method, and a non-transitory computer readable medium storing a program that are capable of improving the monitoring efficiency of a mobile body when the mobile body is remotely monitored and controlled.

### BACKGROUND ART

In recent years, automated driving technologies for vehicles have been actively developed. At an automated driving level of four and above, a driver who performs a driving operation of a vehicle does not ride in the vehicle. Therefore, when something happens to the vehicle, nothing can be done. Since such a situation should be avoided, it is desirable to implement functions of remote monitoring and automated driving control (remote monitoring and control) of vehicles in an automated driving system. In the remote monitoring and control of vehicles, one person who performs monitoring monitors a plurality of vehicles in some cases. Therefore, it is necessary to improve the monitoring efficiency of the vehicles when the vehicles are monitored and controlled, for example, by paying attention to a vehicle in which an accident has occurred and managing it.

Patent Literature 1 discloses a vehicle remote operation support system, including: a vehicle including an automated driving system that performs automated driving; and a control center with an operator, the vehicle including a peripheral sensor that acquires peripheral information of the vehicle and a calling unit that transmits the peripheral information when it is difficult to perform the automated driving and calls the operator, the control center including a remote control unit that remotely controls the vehicle, an input unit that inputs parameters for the operator to select a traveling pattern of the vehicle for the remote control in accordance with the peripheral information, and a route generation unit that selects, from among a plurality of traveling patterns, the traveling pattern of the vehicle for the remote control using the parameters and generates a route for the vehicle using the selected traveling pattern and the peripheral information. Patent Literature 1 does not disclose that the monitoring efficiency of the vehicle is improved when the vehicle is remotely monitored and controlled.

Patent Literature 2 discloses a risk range determination unit that determines a risk range of the surrounding of an automated driving vehicle based on a degree of risk received from an automated driving control apparatus. Further, Patent Literature 2 discloses that the degree of risk can be intuitively understood by displaying a frame image in which a risk range object is superimposed on a display unit of a remote control apparatus. Patent Literature 2 does not disclose that the monitoring efficiency of the vehicle is improved when the vehicle is remotely monitored and controlled.

### CITATION LIST

### Patent Literature

Patent Literature 1: Japanese Unexamined Patent Application Publication No. 2019-191982
Patent Literature 2: International Patent Publication No. WO 2018/155159

### SUMMARY OF INVENTION

### Technical Problem

As described above, in the remote monitoring and control of vehicles, it is necessary for one person who performs monitoring to monitor a plurality of vehicles and to remotely control a vehicle in which it is difficult to perform automated driving among a plurality of vehicles. However, there is a problem that it is difficult for one person who performs monitoring to determine whether or not a remote operation of a specific vehicle among a plurality of vehicles is necessary while he/she is monitoring the plurality of vehicles.

The present disclosure has been made in order to solve the above-described problem and a main object thereof is to provide a remote monitoring and control apparatus, a system, a method, and a non-transitory computer readable medium storing a program that are capable of improving the monitoring efficiency of a mobile body when the mobile body is remotely monitored and controlled.

### Solution to Problem

A remote monitoring and control apparatus according to the present disclosure includes:

determination result acquisition means for acquiring a result of determination as to whether or not a mobile body is able to perform autonomous driving;

display means for displaying at least one of a monitor screen for displaying video image data captured from the mobile body in a direction external thereto for each of a plurality of the mobile bodies and a remote control screen for displaying the video image data of a remotely controlled mobile body selected from among the plurality of the mobile bodies; and

control means for selecting, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

A system according to the present disclosure includes an information acquisition device, a determination device, and a remote monitoring and control apparatus,

the information acquisition device including:
a sensor configured to acquire sensor data indicating information about a traveling state of a mobile body; and
a camera configured to acquire video image data captured from the mobile body in a direction external thereto,

the determination device including:
data acquisition means for acquiring the sensor data and the video image data from the information acquisition device;
autonomous driving determination means for determining whether or not the mobile body is able to perform autonomous driving based on the sensor data; and
communication means for transmitting a result of the determination as to whether or not the mobile body is able to perform autonomous driving to the remote monitoring and control apparatus,

the remote monitoring and control apparatus including:
determination result acquisition means for acquiring the result of the determination from the determination device;
display means for displaying at least one of a monitor screen for displaying video image data for each of a plurality of the mobile bodies and a remote control screen for displaying the video image data of a remotely controlled mobile body selected from among the plurality of the mobile bodies; and
control means for selecting, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

A method according to the present disclosure includes:

acquiring a result of determination as to whether or not a mobile body is able to perform autonomous driving;

performing at least one of displaying, on a monitor screen, video image data captured from the mobile body in a direction external thereto for each of a plurality of the mobile bodies and displaying, on a remote control screen, the video image data of a remotely controlled mobile body selected from among the plurality of the mobile bodies; and

selecting, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

A non-transitory computer readable medium according to the present disclosure stores a program for causing a computer to:

acquire a result of determination as to whether or not a mobile body is able to perform autonomous driving;

perform at least one of displaying, on a monitor screen, video image data captured from the mobile body in a direction external thereto for each of a plurality of the mobile bodies and displaying, on a remote control screen, the video image data of a remotely controlled mobile body selected from among the plurality of the mobile bodies; and

select, when it is determined that a predetermined mobile body is not able to perform autonomous driving, the predetermined mobile body as the remotely controlled mobile body, display the video image data of the predetermined mobile body on the remote control screen, and display the remote control screen in a more emphasized manner than that of the monitor screen.

### Advantageous Effects of Invention

According to the present disclosure, it is possible to provide a remote monitoring and control apparatus, a system, a method, and a non-transitory computer readable medium storing a program that are capable of improving the monitoring efficiency of a mobile body when the mobile body is remotely monitored and controlled.

### BRIEF DESCRIPTION OF DRAWINGS

FIG. 1 is a block diagram illustrating a remote monitoring and control apparatus according to a first example embodiment;

FIG. 2A is a block diagram illustrating a system according to the first example embodiment;

FIG. 2B is a block diagram illustrating the system according to the first example embodiment;

FIG. 3 is a flowchart illustrating operations performed by a monitoring center according to the first example embodiment;

FIG. 4 is a block diagram illustrating a system according to a second example embodiment; and

FIG. 5 is a block diagram illustrating the system according to the second example embodiment.

### EXAMPLE EMBODIMENT

Example embodiments of the present invention will be described hereinafter with reference to the drawings. The same or corresponding elements are denoted by the same reference symbols throughout the drawings, and redundant descriptions will be omitted as necessary for the clarification of the description.

### First Example Embodiment

The configuration of a remote monitoring and control apparatus and a system according to a first example embodiment will be described.

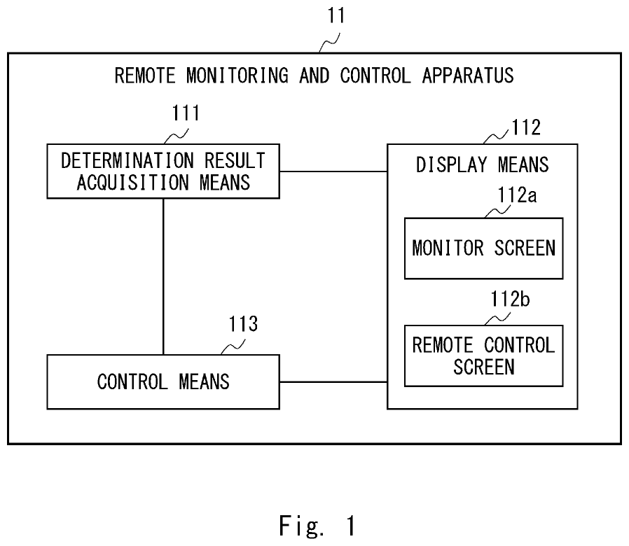

FIG. 1 is a block diagram illustrating the remote monitoring and control apparatus according to the first example embodiment.

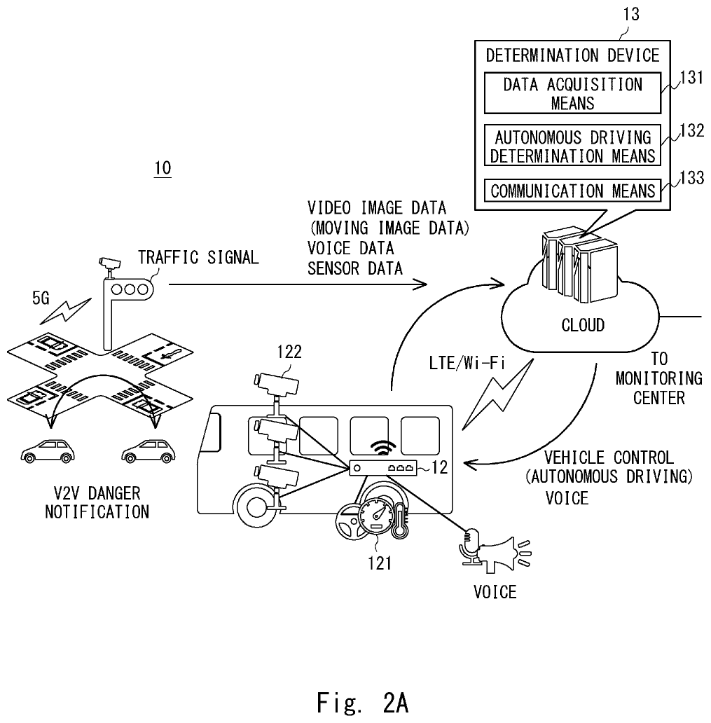

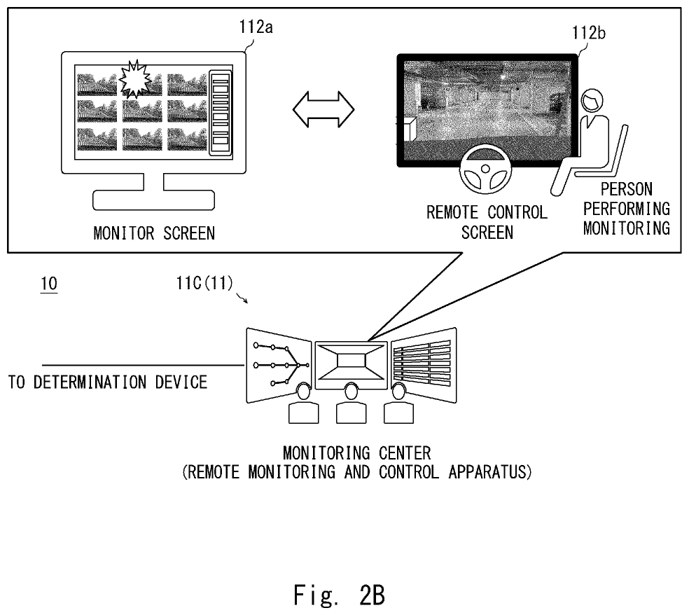

FIG. 2A is a block diagram illustrating the system according to the first example embodiment.

FIG. 2B is a block diagram illustrating the system according to the first example embodiment.

In the first example embodiment, the technology of the present disclosure will be described with reference to an example in which a vehicle is driven automatically. Further, in the first example embodiment, the remote monitoring and control apparatus installed in a monitoring center remotely monitors and controls a vehicle which is a mobile body. However, in the following description, the monitoring center remotely monitors and controls a vehicle. Note that examples of the mobile body include at least one of a vehicle including an automobile, a railway, and the like, an aircraft, and a ship. Further, the monitoring center may be referred to as a control center.

As shown in FIGS. 1, 2A, and 2B, a system 10 according to the first example embodiment includes an information acquisition device 12, a determination device 13, and a monitoring center 11C. A remote monitoring and control apparatus 11 is installed in the monitoring center 11C.

As shown in FIG. 2A, the information acquisition device 12 includes a sensor 121 and a camera 122. The sensor 121 acquires sensor data indicating information about a traveling state of a vehicle. The camera 122 acquires video image data captured from the vehicle in a direction external thereto.

The determination device 13 includes data acquisition means 131, autonomous driving determination means 132, and communication means 133. The determination device 13 may implement the functions of the data acquisition means 131, the autonomous driving determination means 132, and the communication means 133 by using a cloud connected to a communication network.

The data acquisition means 131 may acquire sensor data, image data, and the like obtained by a traffic signal or a sensor such as a camera provided near the traffic signal through the traffic signal or communication means provided near the traffic signal. Further, the data acquisition means 131 may acquire sensor data and video image data using, for example, communication means such as 5 Generation (5G), Long Term Evolution (LTE), and Wi-Fi (registered trademark). The video image data may be referred to as moving image data.

The autonomous driving determination means 132 determines whether or not the vehicle is able to perform autonomous driving based on sensor data acquired from the information acquisition device 12. The determination as to whether or not the vehicle is able to perform autonomous driving may be made using Artificial Intelligence (AI). Further, each vehicle may include AI mounted thereon, whereby, by using the AI, the determination as to whether or not the vehicle is able to perform autonomous driving may be made for each vehicle.

Further, the determination as to whether or not the vehicle is able to perform autonomous driving may be made so that the vehicle can be classified into, for example, the following three classes: a vehicle that is not able to perform autonomous driving, a vehicle that is highly unlikely to be able to perform autonomous driving, or a vehicle that is able to perform autonomous driving.

Further, the determination as to whether or not the vehicle is able to perform autonomous driving may be made in accordance with the type of danger to the vehicle and a possibility that the danger to the vehicle has occurred based on sensor data indicating information about a traveling state of the vehicle.

The communication means 133 transmits a result of the determination regarding the vehicle performed by the autonomous driving determination means 132 to the monitoring center 11C.

As shown in FIGS. 1 and 2B, the monitoring center 11C includes determination result acquisition means 111, display means 112, and control means 113.

The determination result acquisition means 111 acquires, from the determination device 13, a result of the determination indicating whether or not the vehicle is able to perform autonomous driving performed by the autonomous driving determination means 132 of the determination device 13.

The display means 112 can display a monitor screen 112a and a remote control screen 112b. The monitor screen 112a displays video image data captured by the camera 122 for each of a plurality of vehicles. The monitor screen 112a is a screen for a person who performs monitoring to monitor vehicles. That is, the person who performs monitoring monitors the vehicles by using the monitor screen 112a.

The video image data displayed on the monitor screen 112a and the remote control screen 112b is not limited to the video image data captured by the camera 122. The video image data displayed on the monitor screen 112a and the remote control screen 112b may be video image data (images) obtained by processing video image data of the vehicle and its surroundings captured by the camera 122.

The remote control screen 112b displays video image data of a remotely controlled vehicle selected from among a plurality of vehicles. The remote control screen 112b is a screen for a person who performs monitoring to remotely control a vehicle. That is, the person who performs monitoring remotely controls (automatically drives) a vehicle by using the remote control screen 112b. The display means 112 displays at least one of the monitor screen 112a and the remote control screen 112b. The remote control screen may be referred to as a remote driving screen or a remote operation screen. Further, the display means 112 may display both the monitor screen 112a and the remote control screen 112b.

When it is determined that a predetermined vehicle among the plurality of vehicles is not able to perform autonomous driving, the control means 113 selects the predetermined vehicle as a remotely controlled vehicle. The control means 113 displays video image data of the predetermined vehicle on the remote control screen 112b. At this time, the remote control screen 112b is displayed in a more emphasized manner than that of the monitor screen 112a. The control means may be referred to as display changing means.

For example, the control means 113 may make the size of the remote control screen 112b larger than that of the monitor screen 112a, thereby displaying the remote control screen 112b in a more emphasized manner than that of the monitor screen 112a.

The control means 113 may make the size of the remote control screen 112b larger than that of the monitor screen 112a by a predetermined trigger.

When the determination device 13 determines that the predetermined vehicle is not able to perform autonomous driving, a video image captured from the predetermined vehicle in the direction to the front is required since a person who performs monitoring remotely controls the vehicle by using the remote control screen 112b. Therefore, video image data includes at least video image data captured from the vehicle in the direction in which the vehicle travels, that is, in the direction to the front of the vehicle.

Operations performed by the monitoring center according to the first example embodiment will be described.

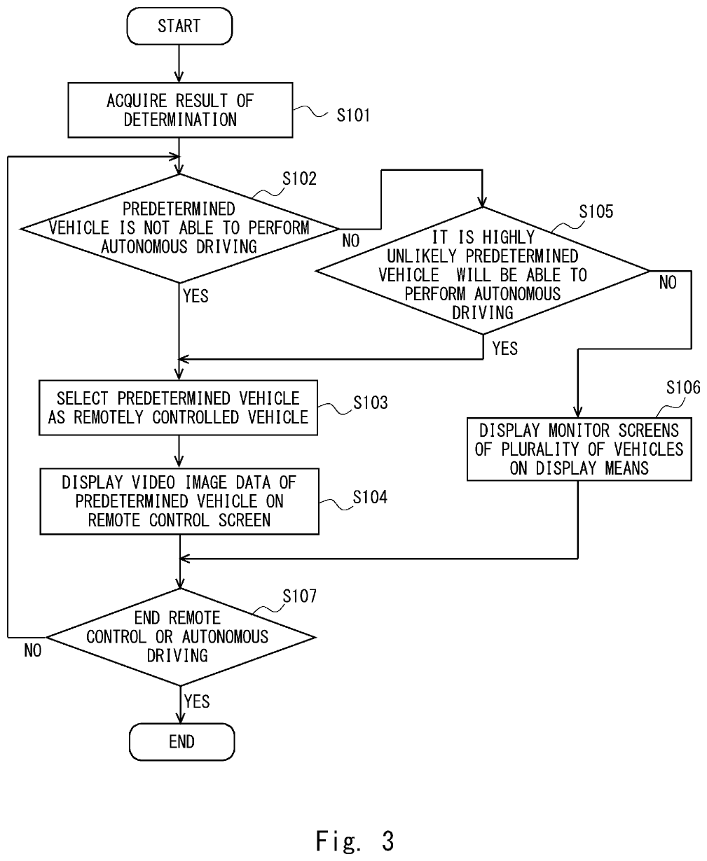

FIG. 3 is a flowchart illustrating operations performed by the monitoring center according to the first example embodiment.

As shown in FIG. 3, the monitoring center 11C acquires a result of determination as to whether or not the vehicle is able to perform autonomous driving (Step S101).

If it is determined that a predetermined vehicle among a plurality of vehicles is not able to perform autonomous driving (Step S102: Yes), the monitoring center 11C selects the predetermined vehicle as a remotely controlled vehicle (Step S103).

The monitoring center 11C displays video image data of the selected predetermined vehicle on the remote control screen 112b. At this time, the remote control screen 112b is displayed in a more emphasized manner than that of the monitor screen 112a (Step S104).

If it is not determined in Step S102 that the predetermined vehicle is not able to perform autonomous driving (Step S102: No), the monitoring center 11C checks whether or not it is highly unlikely that the predetermined vehicle will be able to perform autonomous driving (Step S105).

If it is determined that it is highly unlikely that the predetermined vehicle will be able to perform autonomous driving (Step S105: Yes), the monitoring center 11C performs Step S103.

If it is determined in Step S105 that it is not highly unlikely that the predetermined vehicle will be able to perform autonomous driving (Step S105: No), the monitoring center 11C displays the monitor screens 112a of the plurality of vehicles on the display means (Step S106).

After Steps S104 and S106, the monitoring center 11C checks whether or not to end the remote control or the autonomous driving (Step S107).

If the monitoring center 11C does not end the remote control or the autonomous driving (Step S107: No), the process returns to Step S102. The monitoring center 11C controls display means 212 as described in Steps S101 to S107.

When it is determined that a predetermined vehicle is not able to perform autonomous driving, the monitoring center 11C according to the first example embodiment displays, on the remote control screen 112b, video image data captured from the predetermined vehicle in a direction external thereto. At this time, the monitoring center 11C displays the remote control screen 112b in a more emphasized manner than that of the monitor screen 112a. As a result, since video image data of the predetermined vehicle which it is determined is not able to perform autonomous driving and which requires automated driving is displayed in a more emphasized manner, a person who performs monitoring can check the video image data of the predetermined vehicle on the remote control screen 112b without having to perform any operation. The person who performs monitoring (the remote driver) can then focus on remotely controlling the predetermined vehicle. In this way, the person who performs monitoring can easily perform remote control of a predetermined vehicle required to be remotely controlled while monitoring a plurality of vehicles.

As a result, according to the first example embodiment, it is possible to provide a remote monitoring and control apparatus, a system, a method, and a non-transitory computer readable medium storing a program that are capable of improving the monitoring efficiency of a mobile body (a vehicle) when the mobile body (the vehicle) is remotely monitored and controlled.

Note that, in the first example embodiment, the operations performed when the determination device 13 determines that a predetermined vehicle is not able to perform autonomous driving have been described, and operations similar to these operations may be performed when it is highly unlikely that the predetermined vehicle will be able to perform autonomous driving. That is, the control means 113 may display video image data of a vehicle which it is highly unlikely will be able to perform autonomous driving on the remote control screen 112b in an emphasized manner.

Further, among the monitor screens 112a of a plurality of vehicles, the monitor screen 112a on which video image data of the vehicle which it is determined is not able to perform autonomous driving or which it is highly unlikely will be able to perform autonomous driving is displayed may be emphasized.

Note that, in the first example embodiment, although a description has been given in accordance with the assumption that the autonomous driving determination means 132 of the determination device 13 is provided outside the monitoring center 11C, the present disclosure is not limited thereto. The autonomous driving determination means 132 may be provided inside the monitoring center 11C. That is, the monitoring center 11C may include autonomous driving determination means for determining whether or not the vehicle is able to perform autonomous driving based on sensor data indicating information about a traveling state of the vehicle.

Further, in the first example embodiment, although an example of a case in which a vehicle is monitored and then driven automatically has been described, the present disclosure is not limited thereto. The technology of the present disclosure may be applied not only to the automated driving of a vehicle but also, for example, to the monitoring of road conditions of expressways or the operation management of bullet trains.

Further, in the first example embodiment, although a case has been described in which the display means 112 includes a monitor display for displaying the monitor screen 112a and a remote control display for displaying the remote control screen 112b, the present disclosure is not limited thereto. The display means 112 may include one display and display the monitor screen 112a and the remote control screen 112b on this display. Further, the display means 112 may include three or more displays.

### Second Example Embodiment

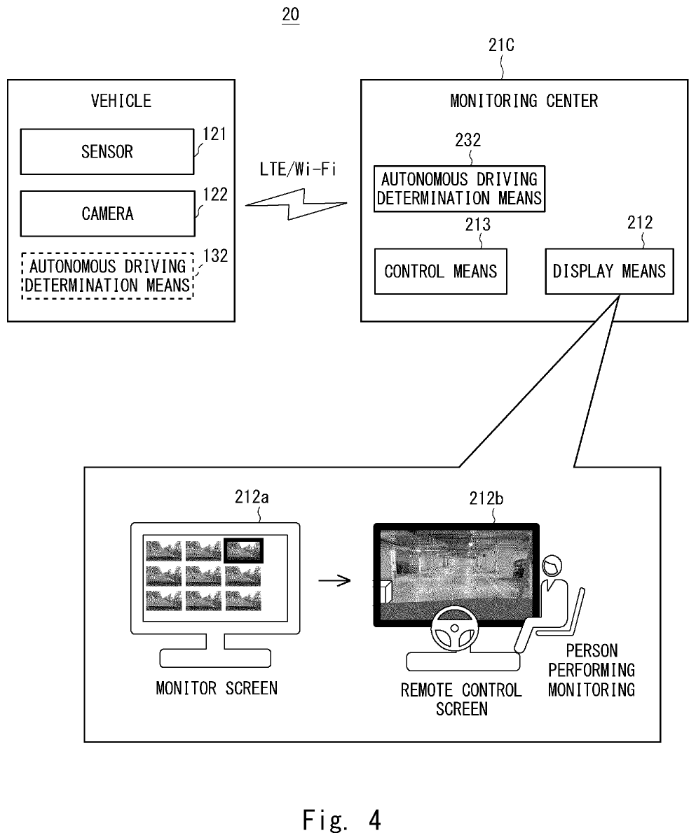

FIG. 4 is a block diagram illustrating a system according to a second example embodiment.

In FIG. 4, autonomous driving determination means 232 is provided inside a monitoring center 21C.

As shown in FIG. 4, a system 20 according to the second example embodiment differs from the system 10 according to the first example embodiment in that the autonomous driving determination means 232 is provided inside the monitoring center 21C.

When the autonomous driving determination means 232 determines that a predetermined vehicle among a plurality of vehicles is not able to perform autonomous driving, control means 213 of the monitoring center 21C according to the second example embodiment switches the display means 212 from the monitor screen 212a on which video image data of the plurality of vehicles are displayed to the remote control screen 212b on which video image data of the predetermined vehicle is displayed. By doing so, it is possible to display the remote control screen 212b in a more emphasized manner than that of the monitor screen 212a.

Further, the control means 213 may perform switching between the monitor screen 212a and the remote control screen 212b by a predetermined trigger. The control means may be referred to as display switching means.

Note that, in the second example embodiment, although a description has been given in accordance with the assumption that the autonomous driving determination means 232 is provided inside the monitoring center 11C, the present disclosure is not limited thereto. The autonomous driving determination means 132 may be provided inside a vehicle (as indicated by a dotted line in FIG. 4) instead of being provided inside the monitoring center 11C.

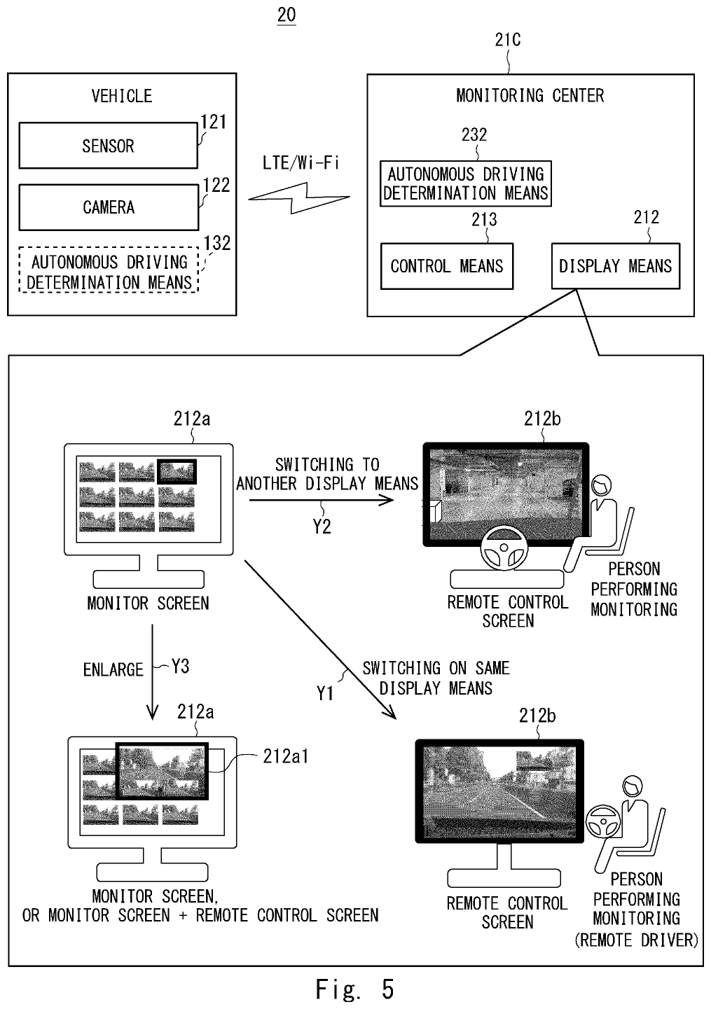

FIG. 5 is a block diagram illustrating the system according to the second example embodiment.

FIG. 5 shows details of the system 20 according to the second example embodiment.

As shown in FIG. 5, when the autonomous driving determination means 232 determines that a predetermined vehicle among a plurality of vehicles to be monitored is not able to perform autonomous driving, the control means 213 switches the display means 212 from the monitor screen 212a to the remote control screen 212b (the remote driving screen) of the predetermined vehicle. At this time, as indicated by an arrow Y1 in FIG. 5, switching is performed on the same display means (the same screen).

Further, when the autonomous driving determination means 232 determines that a predetermined vehicle among a plurality of vehicles to be monitored is not able to perform autonomous driving, the control means 213, as indicated by an arrow Y2 in FIG. 5, may display video image data of the predetermined vehicle on a remote control display for displaying the remote control screen 212b, which is a screen different from the monitor display for displaying the monitor screen 212a.

Further, when the autonomous driving determination means 232 determines that a predetermined vehicle among a plurality of vehicles to be monitored is not able to perform autonomous driving, the control means 213, as indicated by an arrow Y3 in FIG. 5, may display video image data of the predetermined vehicle by setting a part of the display area of the display means 212 as the remote control screen 212b and setting a part of the display area of the display means 212 other than the former part as the monitor screen 212a. At this time, the control means 213 makes the remote control screen 212b larger than the monitor screen 212a. Further, the monitor screen 212a may display video image data of the plurality of vehicles side by side.

Further, when the autonomous driving determination means 232 determines that it is highly unlikely that a predetermined vehicle among a plurality of vehicles to be monitored will be able to perform autonomous driving, the control means 213, as indicated by the arrow Y3 in FIG. 5, may change display forms of the plurality of vehicles to be monitored on the monitor screen 212a. For example, the control means 213 may display an enlarged or emphasized monitor screen 212a1 of the predetermined vehicle. That is, when it is determined that it is highly unlikely that a predetermined vehicle among a plurality of vehicles will able to perform autonomous driving, the control means 213 may display the video image data of the predetermined vehicle on the monitor screen 212a so that the size of the video image data of the predetermined vehicle becomes larger than that of the video image data of the vehicles other than the predetermined vehicle.

Note that although the present invention has been described as a hardware configuration in the above example embodiments, the present invention is not limited thereto. In the present invention, processing of each component can also be implemented by causing a Central Processing Unit (CPU) to execute a computer program.

Further, specifically, each apparatus of an image processing system may be implemented by using a combination of hardware and software. In a form of the combination of hardware and software, an image processing program is developed in a Random Access Memory (RAM), and hardware such as a control unit (Central Processing Unit (CPU)), is operated based on the program, whereby each unit is implemented as various type of means. Further, the program may be recorded on a recording medium and then distributed. The program recorded on the recording medium is loaded into the memory by wire, wirelessly, or via recording medium itself to operate the control unit and the like. Note that examples of the recording medium include an optical disk, a magnetic disk, a semiconductor memory apparatus, and a hard disk.

In the above example embodiments, the program can be stored and provided to a computer using any type of non-transitory computer readable media. Non-transitory computer readable media include any type of tangible storage media. Examples of non-transitory computer readable media include magnetic storage media (specifically, floppy disks, magnetic tapes, and hard disk drives), optical magnetic storage media (specifically, magneto-optical disks), CD-ROM (Read Only Memory), CD-R, CD-R/W, and semiconductor memories (specifically, mask ROM, PROM (Programmable ROM), EPROM (Erasable PROM), flash ROM, and RAM (Random Access Memory)). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present invention has been described with reference to the example embodiments, the present invention is not limited to the above-described example embodiments. Various changes that may be understood by those skilled in the art may be made to the configurations and details of the present invention within the scope of the invention.

Note that the present invention is not limited to the above-described example embodiments and may be changed as appropriate without departing from the spirit of the present invention.

The whole or part of the example embodiments disclosed above can be described as, but not limited to, the following supplementary notes.

(Supplementary Note 1)

A remote monitoring and control apparatus comprising:

determination result acquisition means for acquiring a result of determination as to whether or not a mobile body is able to perform autonomous driving;

display means for displaying at least one of a monitor screen for displaying video image data captured from the mobile body in a direction external thereto for each of a plurality of the mobile bodies and a remote control screen for displaying the video image data of a remotely controlled mobile body selected from among the plurality of the mobile bodies; and

control means for selecting, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

(Supplementary Note 2)

The remote monitoring and control apparatus according to Supplementary note 1, wherein the control means makes a size of the remote control screen larger than a size of the monitor screen, thereby displaying the remote control screen in a more emphasized manner than that of the monitor screen.

(Supplementary Note 3)

The remote monitoring and control apparatus according to Supplementary note 2, wherein the control means makes the size of the remote control screen larger than the size of the monitor screen by a predetermined trigger.

(Supplementary Note 4)

The remote monitoring and control apparatus according to Supplementary note 1, wherein the control means performs switching from the monitor screen to the remote control screen, thereby displaying the remote control screen in a more emphasized manner than that of the monitor screen.

(Supplementary Note 5)

The remote monitoring and control apparatus according to Supplementary note 4, wherein the control means performs switching between the monitor screen and the remote control screen by a predetermined trigger.

(Supplementary Note 6)

The remote monitoring and control apparatus according to any one of Supplementary notes 1 to 5, wherein the display means comprises a monitor display for displaying the monitor screen and a remote control display for displaying the remote control screen.

(Supplementary Note 7)

The remote monitoring and control apparatus according to any one of Supplementary notes 1 to 6, wherein the video image data captured from the mobile body in the direction external thereto includes at least the video image data captured from the mobile body in a direction in which the mobile body travels.

(Supplementary Note 8)

The remote monitoring and control apparatus according to any one of Supplementary notes 1 to 7, wherein the determination as to whether or not the mobile body is able to perform autonomous driving is made in accordance with a type of danger to the mobile body and a possibility that the danger to the mobile body has occurred based on sensor data indicating information about a traveling state of the mobile body.

(Supplementary Note 9)

The remote monitoring and control apparatus according to any one of Supplementary notes 1 to 8, further comprising autonomous driving determination means for determining whether or not the mobile body is able to perform autonomous driving based on the sensor data indicating the information about the traveling state of the mobile body.

(Supplementary Note 10)

The remote monitoring and control apparatus according to any one of Supplementary notes 1 to 9, wherein the mobile body includes at least one of a vehicle, an aircraft, and a ship.

(Supplementary Note 11)

The remote monitoring and control apparatus according to any one of Supplementary notes 1 to 10, wherein when it is determined that it is highly unlikely that a predetermined mobile body will be able to perform autonomous driving, the control means displays the video image data of the predetermined mobile body on the monitor screen so that the size of the video image data of the predetermined mobile body becomes larger than that of the video image data of the mobile bodies other than the predetermined mobile body.

(Supplementary Note 12)

A system comprising an information acquisition device, a determination device, and a remote monitoring and control apparatus,

the information acquisition device comprising:
a sensor configured to acquire sensor data indicating information about a traveling state of a mobile body; and
a camera configured to acquire video image data captured from the mobile body in a direction external thereto,

the determination device comprising:
data acquisition means for acquiring the sensor data and the video image data from the information acquisition device;
autonomous driving determination means for determining whether or not the mobile body is able to perform autonomous driving based on the sensor data; and
communication means for transmitting a result of the determination as to whether or not the mobile body is able to perform autonomous driving to the remote monitoring and control apparatus,

the remote monitoring and control apparatus comprising:
determination result acquisition means for acquiring the result of the determination from the determination device;
display means for displaying at least one of a monitor screen for displaying video image data for each of a plurality of the mobile bodies and a remote control screen for displaying the video image data of a remotely controlled mobile body selected from among the plurality of the mobile bodies; and
control means for selecting, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

(Supplementary Note 13)

A method comprising:

acquiring a result of determination as to whether or not a mobile body is able to perform autonomous driving;

performing at least one of displaying, on a monitor screen, video image data captured from the mobile body in a direction external thereto for each of a plurality of the mobile bodies and displaying, on a remote control screen, the video image data of a remotely controlled mobile body selected from among the plurality of the mobile bodies; and

selecting, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

(Supplementary Note 14)

A non-transitory computer readable medium storing a program for causing a computer to:

acquire a result of determination as to whether or not a mobile body is able to perform autonomous driving;

perform at least one of displaying, on a monitor screen, video image data captured from the mobile body in a direction external thereto for each of a plurality of the mobile bodies and displaying, on a remote control screen, the video image data of a remotely controlled mobile body selected from among the plurality of the mobile bodies; and

select, when it is determined that a predetermined mobile body is not able to perform autonomous driving, the predetermined mobile body as the remotely controlled mobile body, display the video image data of the predetermined mobile body on the remote control screen, and display the remote control screen in a more emphasized manner than that of the monitor screen.

### REFERENCE SIGNS LIST

10, 20 SYSTEM
11 REMOTE MONITORING AND CONTROL APPARATUS
111 DETERMINATION RESULT ACQUISITION MEANS
112, 212 DISPLAY MEANS
112a, 212a, 212a1 MONITOR SCREEN
112b, 212b REMOTE CONTROL SCREEN
113, 213 CONTROL MEANS
11C, 21C MONITORING CENTER
12 INFORMATION ACQUISITION DEVICE
121 SENSOR
122 CAMERA
13 DETERMINATION DEVICE
131 DATA ACQUISITION MEANS
132, 232 AUTONOMOUS DRIVING DETERMINATION MEANS
Y1, Y2, Y3 ARROW

What is claimed is:

1. A remote monitoring and control apparatus comprising:
at least one memory storing instructions, and
at least one processor configured to execute the instructions to;
acquire a result of determination as to whether or not a mobile body is able to perform autonomous driving;
display at least one of a monitor screen for displaying video image data captured from the mobile body in a direction external thereto for each of a plurality of the mobile bodies and a remote control screen for displaying the video image data of a remotely controlled mobile body selected from among the plurality of the mobile bodies; and
select, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

2. The remote monitoring and control apparatus according to claim 1, wherein the at least one processor is configured to make a size of the remote control screen larger than a size of the monitor screen, thereby displaying the remote control screen in a more emphasized manner than that of the monitor screen.

3. The remote monitoring and control apparatus according to claim 2, wherein the at least one processor is configured to make the size of the remote control screen larger than the size of the monitor screen by a predetermined trigger.

4. The remote monitoring and control apparatus according to claim 1, wherein the at least one processor is configured to perform switching from the monitor screen to the remote control screen, thereby displaying the remote control screen in a more emphasized manner than that of the monitor screen.

5. The remote monitoring and control apparatus according to claim 4, wherein the at least one processor is configured to perform switching between the monitor screen and the remote control screen by a predetermined trigger.

6. The remote monitoring and control apparatus according to claim 1, further comprising a monitor display for displaying the monitor screen and a remote control display for displaying the remote control screen.

7. The remote monitoring and control apparatus according to claim 1, wherein the video image data captured from the mobile body in the direction external thereto includes at least the video image data captured from the mobile body in a direction in which the mobile body travels.

8. The remote monitoring and control apparatus according to claim 1, wherein the determination as to whether or not the mobile body is able to perform autonomous driving is made in accordance with a type of danger to the mobile body and a possibility that the danger to the mobile body has occurred based on sensor data indicating information about a traveling state of the mobile body.

9. The remote monitoring and control apparatus according to claim 1, wherein the t least one processor is further configured to determine whether or not the mobile body is able to perform autonomous driving based on the sensor data indicating the information about the traveling state of the mobile body.

10. The remote monitoring and control apparatus according to claim 1, wherein the mobile body includes at least one of a vehicle, an aircraft, and a ship.

11. The remote monitoring and control apparatus according to claim 1, wherein when it is determined that it is highly unlikely that a predetermined mobile body will be able to perform autonomous driving, the at least one processor is configured to display the video image data of the predetermined mobile body on the monitor screen so that the size of the video image data of the predetermined mobile body becomes larger than that of the video image data of the mobile bodies other than the predetermined mobile body.

12. A system comprising an information acquisition device, a determination device, and a remote monitoring and control apparatus,
the information acquisition device comprising:
a sensor configured to acquire sensor data indicating information about a traveling state of a mobile body; and
a camera configured to acquire video image data captured from the mobile body in a direction external thereto,
the determination device comprising:
at least one first memory storing instructions, and
at least one first processor configured to execute the instructions to;
acquire the sensor data and the video image data from the information acquisition device;
determine whether or not the mobile body is able to perform autonomous driving based on the sensor data; and
transmit a result of the determination as to whether or not the mobile body is able to perform autonomous driving to the remote monitoring and control apparatus,
the remote monitoring and control apparatus comprising:
at least one second memory storing instructions, and
at least one second processor configured to execute the instructions to;
acquire the result of the determination from the determination device;
display at least one of a monitor screen for displaying video image data for each of a plurality of the mobile bodies and a remote control screen for displaying the video image data of a remotely controlled mobile body selected from among the plurality of the mobile bodies; and
select, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

13. A method comprising:
acquiring a result of determination as to whether or not a mobile body is able to perform autonomous driving;
performing at least one of displaying, on a monitor screen, video image data captured from the mobile body in a direction external thereto for each of a plurality of the mobile bodies and displaying, on a remote control screen, the video image data of a remotely controlled mobile body selected from among the plurality of the mobile bodies; and
selecting, when it is determined that a predetermined mobile body is not able to perform autonomous driving, the predetermined mobile body as the remotely controlled mobile body, displaying the video image data of the predetermined mobile body on the remote control screen, and displaying the remote control screen in a more emphasized manner than that of the monitor screen.

14. (canceled)
